(19) United States
(12) Patent Application Publication
(10) Pub. No.: US 2003/0076365 A1
(43) Pub. Date: Apr. 24, 2003

(54) Preview and postview thumbnails

(76) Inventors: Robert Sesek, Meridian, ID (US); Travis J. Parry, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/982,343

(22) Filed: Oct. 18, 2001

(51) Int. Cl. G09G 5/00

(52) U.S. Cl. 345/838; 345/764

(57) ABSTRACT

An interactive delivery interface provides a user with a multiple page display. A display job is processed into ordered pages. One of the multiple pages is selected for display on either a display screen or print media. The selected page is scaled to fit the display. At least one sequence of pages adjacent the selected page is chosen. Each page of each chosen sequence of pages is scaled to a size smaller than a size of the selected page. The selected page and each chosen sequence of scaled pages are displayed together on the display.

### FIELD OF THE INVENTION

This invention relates in general to multiple page displays and, more particularly, to a multiple page display with ordered pages of various sizes.

### BACKGROUND OF THE INVENTION

Typically, pages of a document or presentation are created with the expectation they will be displayed one at a time, either on printed media or a display screen. Content presented on each page is sized so that it will be decipherable and convey information.

In some instances, it is desirable to display more than one page on a single display. For example, during a presentation where pages are displayed to observers, providing an indication to the presenter of the contents of preceding and following pages could help the presenter better deliver the presentation.

Conventionally, displaying multiple pages on a single display requires each page be displayed at the same scale. Many software applications allow a user to display multiple pages simultaneously at a reduced scale. Displaying the pages at a scale smaller than the scale in which they were intended reduces the decipherability of the pages and reduces the amount of information conveyed to the observer.

Despite the reduction in conveyed information, displaying pages at a reduced scale is often useful. For example, reducing the scale of the pages allows multiple pages to be presented together on a single display. Pages are frequently scaled to a small size and displayed simultaneously on a display in order to save display space and more quickly review the pages. Usually, pages may be easily scaled to about one quarter size and still convey almost all of the information they were intended to convey.

Thumbnails are very small-scale representations of a page or image. Thumbnails are useful for providing observers with an indication of the contents of a page or image. Conventionally, thumbnails are used to display many pages or images at once. The observer is then able to receive some information about each page or image represented by a thumbnail. The observer may then select pages or images from the thumbnails and view the full size page or image represented by the thumbnail. In this way, the observer may easily select pages or images for viewing without being required to view each full size image or page.

While thumbnails are useful for providing an indication of the contents of a page or image, thumbnails are usually too small to effectively convey all of the information that a full sized page is able to covey. Therefore, a presenter may find thumbnails to be useful while making a presentation. However, the presenter may also want to see the current page of the presentation at full size. The conventional means for displaying multiple pages simultaneously do not enable displaying of both thumbnails and a full size page simultaneously on a single display.

### SUMMARY OF THE INVENTION

According to principles of the present invention, an interactive delivery interface provides a user with a multiple page display. A display job is processed into ordered pages. One of the multiple pages is selected for display. At least one sequence of pages adjacent the selected page is chosen. Each page of each chosen sequence of pages is scaled to a size smaller than a size of the selected page. The selected page and each chosen sequence of scaled pages are displayed together on the display.

According to further principles of the present invention, the ordered pages of the display job are processed into sequential pages.

According to further principles of the present invention, examples of displaying the selected page and each chosen sequence of scaled pages include exhibiting the selected page and each chosen sequence of scaled pages on a display screen and printing the selected page and each chosen sequence of scaled pages onto print media.

According to further principles of the present invention, the selected page is scaled to fit the display and each page in each chosen sequence of pages is scaled to a size smaller than a size of the scaled selected page.

### DESCRIPTION OF THE DRAWINGS

FIG. 1 is a block diagram representing one embodiment of the system of the present invention for displaying multiple pages of a display job on a display.

FIG. 2 is a flow chart illustrating one embodiment of the method of the present invention for displaying multiple pages of a display job on a display.

FIG. 3 is a representation of examples of multiple page displays for the present invention.

### DETAILED DESCRIPTION OF THE INVENTION

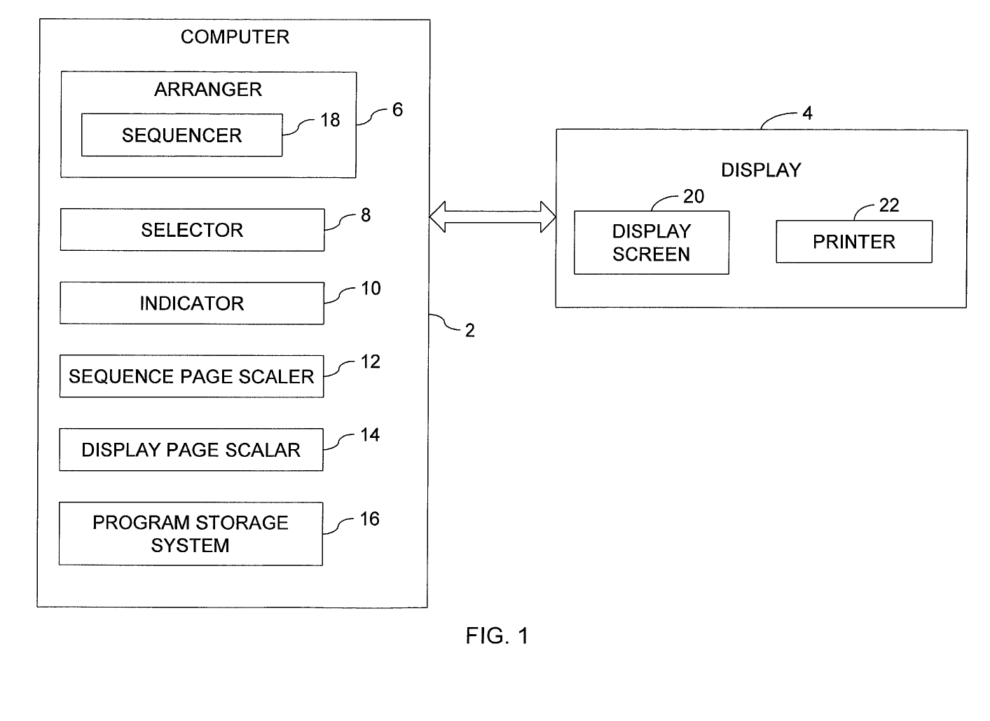

FIG. 1 shows, in block diagram form, a system for displaying a multiple page display job on a display. The system includes computer 2 and display 4.

Computer 2 is any device or system, such as a specific or general purpose computer, that includes a means, such as a processor, configured to process executable code. Computer 2 includes an arranger 6, a selector 8, an indicator 10, a sequence page scaler 12, a display page scaler 14, and a program storage system 16.

Arranger 6 is any combination of hardware and executable code configured to process the display job into ordered pages. Arranger 6 includes a sequencer 18. Sequencer 18 is any combination of hardware and executable code configured to process the displayed job into sequential pages.

Selector 8 is any combination of hardware and executable code configured to select one of the multiple pages for display. Indicator 10 is any combination of hardware and executable code configured to choose at least one sequence of pages adjacent the selected page. Sequence page scaler 1 2 is any combination of hardware and executable code configured to scale each page in each chosen sequence of pages to a size smaller than a size of the selected page. Display page scaler 14 is any combination of hardware and executable code configured to scale the selected page to fit the display.

Program storage system 16 is any system configured to store data or executable code. In one embodiment, program storage system 16 is a program storage device tangibly embodying a program, applet, or instructions executable by computer 2 for performing the method steps of the present invention executable by computer 2. Program storage system 16 may be any type of storage media such as magnetic, optical, or electronic storage media. Although depicted as integral to computer 2, program storage system 16 is alternatively embodied separate from computer 2 and accessible by computer 2.

Display 4 is any device or system configured to display the display job. In one embodiment, display 4 includes a display screen 20. Display screen 20 is any combination of hardware and executable code configured to exhibit the selected page and each chosen sequence of scaled pages. In an alternative embodiment, display 4 includes a printer 22. Printer 22 is any combination of hardware and executable code configured to print the selected page and each chosen sequence of scaled pages onto print media.

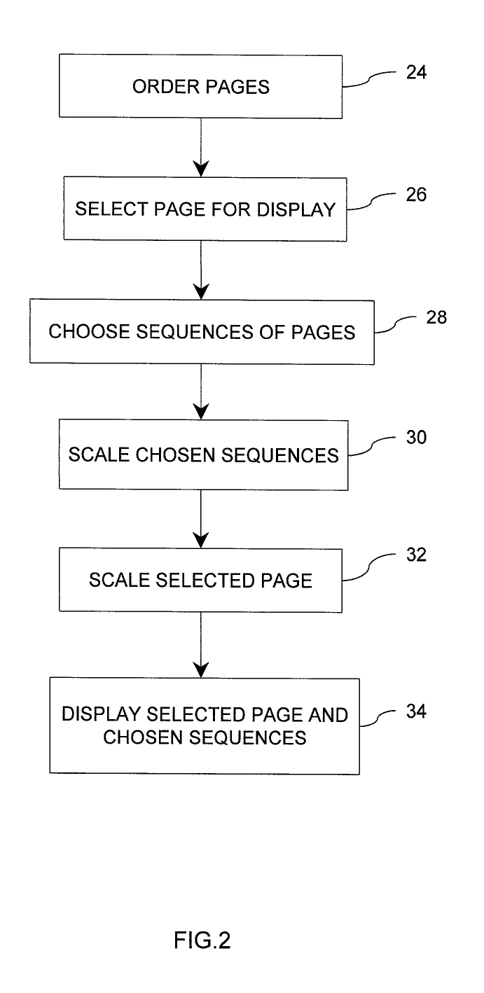

FIG. 2 is a flow chart representing steps of one embodiment of the present invention. Although the steps represented in FIG. 2 are presented in a specific order, the present invention encompasses variations in the order of steps. Furthermore, additional steps may be executed between the steps illustrated in FIG. 2 without departing from the scope of the present invention.

Pages of a multiple page display job are ordered 24. In one embodiment, arranger 6 orders 24 the display job into ordered pages. The pages are ordered 24 according to their location in a presentation or document. For example, in a linear document or presentation, the pages are ordered sequentially. In a document having multiple pages in each of two dimensions, the pages are ordered by row and column.

One of the multiple pages of the display job is selected 26 for display. In one embodiment, selector 8 selects 26 the page for display. The method of the present invention may be practiced individually on each page of the display job.

At least one sequence of pages adjacent the selected page is chosen 28. In one embodiment, indicator 10 chooses 28 the sequence of pages. Each sequence of pages is one or more pages.

Each page in each chosen sequence of pages is scaled 30 to a size smaller than a size of the selected page. In one embodiment, sequence page scaler 12 scales 30 each page. The pages may be scaled to any size smaller than the selected pages but scaling the pages to a thumbnail size is convenient.

If necessary or desirable, the selected page is scaled 32. The selected page may be scaled to fit display 4 or to make room for the sequences. In one embodiment, display page scaler 14 scales 32 the selected page.

The selected page and each chosen sequence of scaled pages are displayed 34 together on display 4. In one embodiment, the selected page and each chosen sequence of scaled pages are displayed 4 together on display screen 20. In an alternative embodiment, the selected page and each chosen sequence of pages are displayed 4 together onto print media from printer 22.

Each page of each chosen sequence can be displayed at any location of display 4. In one embodiment, each page of each chosen sequence is displayed on the selected page according to its location relative to the selected page. For example, if the pages of the chosen sequence immediately precede the selected page, the pages are displayed in the left margin of the selected page. If the pages of the chosen sequence immediately follow the selected page, the pages are displayed in the right margin of the selected page.

The present invention is also useful where a spreadsheet encompasses multiple pages. For example, where a document is larger than can be displayed in a readable size on a single display, the chosen sequences may be placed at the upper, lower, left or right margins of display 4 to indicate the relative location of the chosen sequences to the selected page.

In another example, each chosen sequence is displayed along the lower margin of the selected page. For example, if the pages of the chosen sequence immediately precede the selected page, the pages are displayed at the lower left-hand corner of the selected page. Alternatively, if the pages of the chosen sequence immediately follow the selected page, the pages are displayed at the lower right-hand corner of the selected page. Locating the pages of the chosen sequences in the margins of the display leaves the majority of the selected page unobstructed.

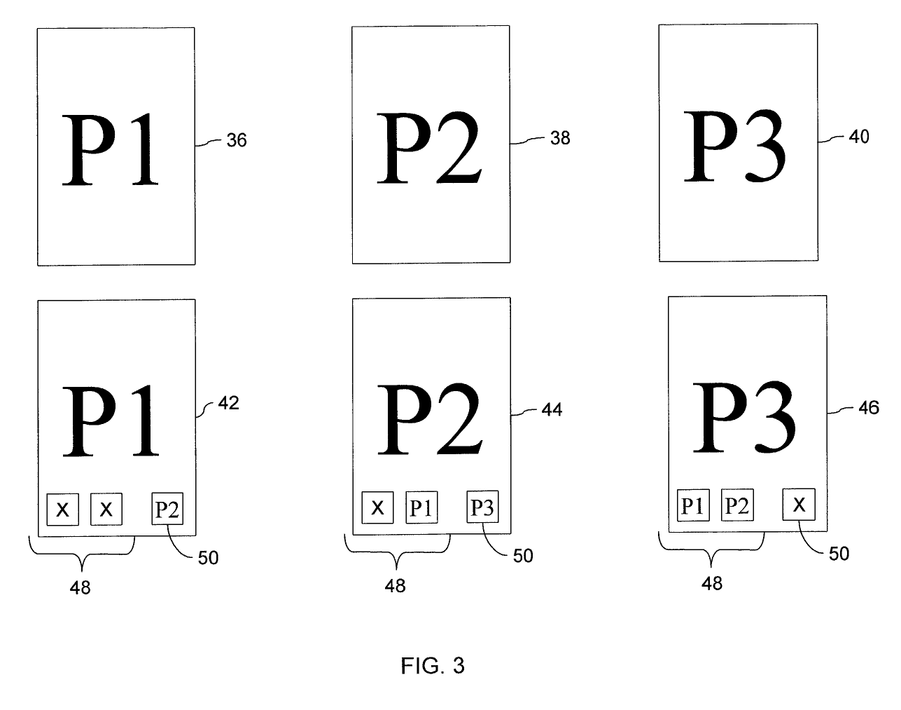

FIG. 3 illustrates examples of single page displays 36, 38, 40, and multiple page displays 42, 44, 46.

P1, P2, P3 represent three pages of a display job. X represents a nonexisting page, such as before the first page or after the last page of a document.

Pages P1, P2, P3 are ordered 24 by arranging them in sequential order. Each page P1, P2, P3 is selected 26 in turn for display. In this example, two sequences 48, 50 of pages are chosen 28.

Sequence 48 is a sequence of two pages before the selected page. Sequence 50 is a sequence of one page after the selected page.

Sequences 48, 50 are scaled 30 to a size smaller than the selected page. If necessary, the selected page is scaled 32 to fit display 4. If the selected page was scaled, sequences 48, 50 are scaled 32 with the selected page. The selected page and the chosen sequences are displayed 34 together as shown in multiple page displays 42, 44, 46.

The foregoing description is only illustrative of the invention. Various alternatives and modifications can be devised by those skilled in the art without departing from the invention. Accordingly, the present invention embraces all such alternatives, modifications, and variances that fall within the scope of the appended claims.

What is claimed is:

1. A method for displaying multiple pages of a display job on a display, the method comprising:
(a) processing a display job into ordered pages;
(b) selecting one of the multiple pages for display;
(c) choosing at least one sequence of pages adjacent the selected page;
(d) scaling each page in each chosen sequence of pages to a size smaller than a size of the selected page; and,
(e) displaying the selected page and each chosen sequence of scaled pages together on the display.

2. The method of claim 1 wherein processing the display job into ordered pages includes processing the displayed job into sequential pages.

3. The method of claim 1 wherein displaying the selected page and each chosen sequence of scaled pages includes exhibiting the selected page and each chosen sequence of scaled pages on a display screen.

4. The method of claim 1 wherein displaying the selected page and each chosen sequence of scaled pages includes printing the selected page and each chosen sequence of scaled pages onto print media.

5. The method of claim 1 further including scaling the selected page.

6. The method of claim 5 wherein scaling each page in each chosen sequence of pages includes scaling each page in each chosen sequence to a size smaller than the size of the scaled selected page.

7. A system for displaying multiple pages of a display job, the system comprising:
(a) an arranger configured to process the display job into ordered pages;
(b) a selector configured to select one of the multiple pages for display;
(c) an indicator configured to choose at least one sequence of pages adjacent the selected page;
(d) a sequence page scaler configured to scale each page in each chosen sequence of pages to a size smaller than a size of the selected page; and,
(e) a display configured to display the selected page and each chosen sequence of scaled pages together on the display.

8. The method of claim 7 wherein the arranger includes a sequencer configured to process the displayed job into sequential pages.

9. The system of claim 7 wherein the display includes a display screen.

10. The system of claim 7 wherein the display includes a printer configured to print the selected page and each chosen sequence of scaled pages onto print media.

11. The system of claim 7 further including a display page scaler configured to scale the selected page.

12. The system of claim 11 wherein the sequence page scaler further scales each page in each chosen sequence to a size smaller than the size of the scaled selected page.

13. A program storage system readable by a computer, tangibly embodying a program, applet, or instructions executable by the computer to perform method steps displaying multiple pages of a display job on a display, the method steps comprising:
(a) processing a display job into ordered pages;
(b) selecting one of the multiple pages for display;
(c) choosing at least one sequence of pages adjacent the selected page;
(d) scaling each page in each chosen sequence of pages to a size smaller than a size of the selected page; and
(e) displaying the selected page and each chosen sequence of scaled pages together on the display. The method of claim 7 wherein the arranger includes a sequencer for processing the displayed job into sequential pages.

14. The program storage system of claim 13 wherein the method step of processing the display job into ordered pages includes processing the displayed job into sequential pages.

15. The program storage system of claim 13 wherein the method step of displaying the selected page and each chosen sequence of scaled pages includes exhibiting the selected page and the at least one sequence of scaled pages on a display screen.

16. The program storage system of claim 13 wherein the method step of displaying the selected page and each chosen sequence of scaled pages includes printing the selected page and the at least one sequence of scaled pages onto print media.

17. The program storage system of claim 13 wherein the method step further includes scaling the selected page.

18. The program storage system of claim 17 wherein the method step of scaling each page in each chosen sequence of pages includes scaling each page in the sequence to a size smaller than the size of the scaled selected page.
